(19) United States
(12) Patent Application Publication
(10) Pub. No.: US 2009/0093591 A1
(43) Pub. Date: Apr. 9, 2009

(54) Processing aid for melt-extrudable polymers

(76) Inventors: Donald F. Lyons, Wilmington, DE (US); Steven R. Oriani, Landenberg, PA (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(21) Appl. No.: 11/973,445

(22) Filed: Oct. 9, 2007

(51) Int. Cl. C08F 214/18; C08L 27/12

(52) U.S. Cl. 525/200; 525/199

(57) ABSTRACT

An extrudable composition comprising a non-fluorinated, melt processable host polymer and from about 25 parts per million by weight to about 50% by weight, based on total weight of said extrudable composition, of a fluoropolymer consisting essentially of copolymerized units of from 45 to 95 mole percent, based on total weight of said fluoropolymer, of tetrafluoroethylene (TFE) and from 5 and 55 mole percent, based on total weight of said fluoropolymer, of 3,3,3-trifluoropropylene (TFP).

### BACKGROUND OF THE INVENTION

The present invention relates to fluoroelastomer processing aids which improve extrusion characteristics of melt-extrudable, i.e., melt-processable, polymers, especially non-fluorinated thermoplastic polymers. More particularly, the present invention relates to a composition and method for improving melt-extrusion of such polymers by incorporating into the polymer a fluoroelastomer processing aid based on tetrafluoroethylene (TFE) and an effective amount of 3,3,3-trifluoropropylene (TFP).

Melt extrusion of high molecular weight thermoplastic polymers, such as, for example, polyamides, polyesters and polyolefins, into shaped articles, such as tubing, pipe, wire coating or film is accomplished by well-known procedures wherein a rotating screw pushes a viscous polymer melt through an extruder barrel into a die in which the polymer is shaped to the desired form, and the extrudate, i.e., the shaped article, is then either quenched or allowed to cool slowly to temperatures below the melting point and assume the shape of the die orifice.

In order to lower unit production costs, it is desirable to extrude the polymer at as high a speed as possible. Higher extrusion rates may be readily obtained by increasing the rate of revolution of the extruder screw. However, this technique is subject to limitations imposed by the viscoelastic properties of the polymer being processed. Flow instabilities can occur when certain critical conditions, such as viscosity and material throughput, are exceeded. At very high extrusion rates shear heating can result in an unacceptable amount of thermal decomposition of the polymer, and for certain polymers extrudate distortions, such as surface melt fracture (i.e., sharkskin), stick-slip and gross melt fracture have been observed.

The majority of advancements in fluoropolymer process aid technology have focused on the use of process aids in relatively non-polar aliphatic polymers, such as polyolefins or modified polyolefins. Even when non-aliphatic polar polymers, such as polyamides and polyesters are listed as potentially suitable host resins, their use is rarely exemplified.

Blatz, U.S. Pat. No. 3,125,547, describes the use of 0.01-2.0 wt. % of a fluoropolymer that is in a fluid state at the process temperature to improve processability of melt extrudable olefins and modified olefins. Among the fluoropolymers identified as useful in improving processability are those containing monomer units of tetrafluoroethylene, chlorotrifluoroethylene, vinylidene fluoride, and hexafluoropropylene, provided the ratio of atomic fluorine to carbon is at least 1:2. Especially preferred are fluorocarbon rubbers, such as copolymers of hexafluoropropylene and vinylidene fluoride.

Finlay, U.S. Pat. No. 4,529,784, describes an elastomeric copolymer of tetrafluoroethylene and perfluoro(methyl vinyl) ether having a cure site monomer of the formula R₁CH═CR₂R₃ wherein R₁ and R₂ are independently selected from hydrogen and fluorine, and R₃ is independently selected from hydrogen, fluorine, alkyl, and perfluoroalkyl. These elastomeric copolymers have been observed to exhibit excellent crosslink stability and good resistance to organic bases and other fluids, but they are not shown to be effective as process aids for either non-polar or polar polymers.

Chapman et al., U.S. Pat. 5,464,904, disclose the use of partially crystalline TFE-HFP polymers for use as process aids in polyolefins. The patent teaches that exceptional performance is obtained when the end-of-melting temperature of the TFE-HFP polymer is within 20° C. of the processing temperature of the host resin.

Anolick et al., U.S. Pat. No. 6,486,280 B1, describe amorphous tetrafluoroethylene-hexafluoropropylene (TFE-HFP) copolymers which can be used as, among other applications, processing aids in polyolefins, such as high molecular weight, high density polyethylene and linear low density ethylene copolymers, i.e., non-polar polymers. Processability of polar polymers is not mentioned. Among the amorphous copolymers described are those containing repeat units derived from hexafluoropropylene (HFP), one or more second monomers, with the balance tetrafluoroethylene (TFE), wherein the second monomer can be 3,3,3-trifluoropropene.

Lavallee et al., U.S. Pat. 6,780,481, disclose the use of certain fluoropolymers as process aids for non-aliphatic host resins. The fluoropolymers comprise at least two monomers, at least one of which is fluorinated. The fluorinated monomers are selected based upon criteria that exclude 3,3,3-trifluoropropylene (TFP).

Dillon et al., U.S. Pat. 6,380,313, disclose fluoropolymers that have been modified to include units derived from a substituted perfluorovinyl ether. The fluoropolymers are suitable for use in polar, non-hydrocarbon host resins, or hydrocarbon host resins containing aggressive additives such as hindered amine light stabilizers. In addition to the perfluorovinyl ether monomer, the claimed fluoropolymers comprise 60-99.9% by weight of a fluoromonomer that, based on the selection criteria, excludes 3,3,3-trifluoropropylene (TFP).

Chapman et al., U.S. Pat. 5,132,368, discloses extrudable compositions comprising a host resin and 0.002-0.5 wt. % fluoropolymer. Both non-polar polyolefin and polar aliphatic and non-aliphatic host resins are exemplified. The fluoropolymer is selected from poly-TFE or TFE co-polymerized with a perfluoromonomer, and contains certain functional groups.

Thus, there is an ongoing need for improved economical fluoropolymer processing aids which improve extrusion characteristics of melt-extrudable, i.e., melt-processable, polymers. Improvements in extrusion characteristics of such polymers may be observed through one or more of the following attributes: (i) reduced die pressure; (ii) increased extruder output for a given screw speed; (iii) reduced occurrence of melt defects, such as melt fracture; or (iv) a reduction in the tendency for such polymers to create die lip build-up during extrusion.

### SUMMARY OF THE INVENTION

The present invention is an extrudable composition comprising a non-fluorinated melt-processable polymer (i.e., host polymer) comprising from about 25 parts per million to about 50% by wt, based on the total weight of said extrudable composition, of a fluoropolymer consisting essentially of copolymerized units of the following monomers:

A) from 45 to 95 mole percent, based on total weight of said fluoropolymer, of tetrafluoroethylene (TFE); and

B) from 5 to 55 mole percent, based on total weight of said fluoropolymer, of 3,3,3-trifluoropropylene (TFP).

Typical concentrations of the fluoropolymer in the host resin during the final shaping step of the host resin range from 25 to 2000 ppm, based on the total weight of the extrudable composition. Higher concentrations, up to about 50% by weight of the TFE-TFP fluoropolymer in a melt-processable polymer are useful as masterbatches to facilitate dosing to the extruder during the final shaping step.

In a preferred embodiment, TFE is present in the fluoropolymer at a level of at least 70 mole percent, based on total weight of the fluoropolymer, and TFP is present in the fluoropolymer at a level of at least 15 mole percent, based on total weight of the fluoropolymer.

In another embodiment, the present invention is a method for improving extrusion characteristics of a melt-processable polymer by incorporating into the polymer from about 25 parts per million to about 50% by wt, based on the total weight of the polymer, of a fluoropolymer consisting essentially of copolymerized units of the following monomers:

A) from 45 to 95 mole percent, based on total weight of said fluoropolymer, of tetrafluoroethylene (TFE); and

B) between 5 to 55 mole percent, based on total weight of said fluoropolymer, of 3,3,3-trifluoropropylene (TFP).

During extrusion, the fluoropolymer is thought to accumulate as a thin layer on internal surfaces of process equipment. As a thin layer, the fluoropolymer tends to (i) induce a slip velocity that can delay the onset of melt fracture of the host polymer to higher shear rates, (ii) lower the incidence of die build-up caused by the accumulation of host polymer or additives on the die face, and (iii) reduce the shear stress of the flowing host polymer thereby reducing the pressure upstream of the die and/or increasing the extruder output for a given screw speed (rpm).

### BRIEF DESCRIPTION OF THE DRAWINGS

FIG. 1 is a graph comparing die pressure in MPa to extruder output (g/min) for sample compositions produced and tested according to the invention, along with a control composition.

### DETAILED DESCRIPTION OF THE INVENTION

The present invention resides in the discovery that trifluoropropylene (TFP) acts as a metal adhesion promoter when interpolymerized with tetrafluroroethylene (TFE). It has been observed that the presence of TFP, which co-polymerizes readily with TFE, effectively interrupts the crystallinity of TFE, thereby reducing the melt temperature (Tₘ) of the resulting fluoropolymer composition below the process temperature for the host polymers described herein. In addition, polymers containing copolymerized TFP units demonstrate sufficient metal adhesion for rapid accumulation on internal surfaces of process equipment, but they do not adhere strongly to polar host polymers, such as polyamides (nylon) and polyesters, e.g., polyethylene(terephthalate) (PET). Thus, the inventive fluoropolymer compositions which contain TFP can function effectively as a processing aid for both polar and non-polar host polymer resins.

The present invention is directed according to one embodiment to a composition that provides improved extrusion processability of non-fluorinated and melt-extrudable, i.e., melt-processable, polymers having commercial value in a variety of extruded shaped articles. Examples of non-fluorinated melt-processable polymers usefully according to the invention include, but are not limited to, hydrocarbon resins, polyamides, chlorinated polyethylene, polyvinyl chloride, and polyesters. By the term “non-fluorinated” it is meant that the ratio of fluorine atoms to carbon atoms present in the polymer is less than 1:1.

Non-fluorinated melt-processable polymers useful according to the invention may be selected from a variety of polymer types. Such polymers include hydrocarbon polymers having melt indexes (measured according to ASTM D1238 at 190° C., using a 2160 g weight) of 50.0 g/10 minutes or less, preferably 20.0 g/10 minutes or less, and especially less than 5.0 g/10 minutes. The hydrocarbon polymers may be elastomeric copolymers of ethylene, propylene, and optionally a non-conjugated diene monomer, for example 1,4-hexadiene. In general, hydrocarbon polymers also include any thermoplastic hydrocarbon polymer obtained by the homopolymerization or copolymerization of a monoolefin of the formula CH₂═CHR, where R is H or an alkyl radical, usually of not more than eight carbon atoms. In particular, this invention is applicable to polyethylene, of both high density and low density, for example, polyethylenes having a density within the range 0.85 to 0.97 g/cm³; polypropylene; polybutene-1; poly(3-methylbutene); poly(methylpentene); and copolymers of ethylene and alpha-olefins such as propylene, butene-1, hexene-1, octene-1, decene-1, and octadecene. Hydrocarbon polymers may also include vinyl aromatic polymers such as polystyrene and co-polymers of styrene and butadiene or isoprene. Because specific hydrocarbon polymers exhibit differing melt characteristics, the practice of this invention may have greater utility in some hydrocarbon polymers than in others. Thus, hydrocarbon polymers such as polypropylene and branched polyethylene that are not of high molecular weight have favorable melt flow characteristics even at lower temperatures, so that surface roughness, die build-up, or excessive die pressures can be avoided by adjusting extrusion conditions. These hydrocarbon polymers may only require the use of a fluoropolymer extrusion aid according to the invention under unusual and exacting extrusion conditions. However, other polymers, such as high molecular weight, high density polyethylene, linear low density polyethylene copolymers, high molecular weight polypropylene, and propylene copolymers with other olefins, particularly those with narrow molecular weight distributions, do not permit this degree of freedom in variation of extrusion conditions. It is particularly with these resins that improvements in the surface quality of the extruded product or reductions in die pressure are obtained by using the fluoropolymer described herein according to this invention.

Other non-fluorinated melt-processable polymers that may benefit by incorporating therein a fluoropolymer described herein according to the invention include polyamides and polyesters. Specific examples of polyamides useful in the practice of this invention are nylon 6, nylon 6/6, nylon 6/10, nylon 11 and nylon 12. Suitable polyesters include poly(ethylene terephthalate) and poly(butylene terephthalate) and their co-polymers with terephthalic acid or cyclohexanedimethanol. Best results have been observed when the host resin is a poly(ethylene terphthalate) homo- or co-polymer having an intrinsic viscosity of at least 0.6 dl/g, and preferably at least 0.7 dl/g.

Melt-processable polymers that can benefit from the invention can also contain an interfacial agent. The weight ratio of interfacial agent to fluoroelastomer may range from 0.1 to 3.0 (but usually in the range of from 0.2 to 2.0). More than one interfacial agent may be employed in the method according to this invention, wherein the weight ratio of total interfacial agent to fluoroelastomer is in the range of from 0.1 to 3.0.

By “interfacial agent” is meant a compound that is different from the fluoroelastomer process aid and any host polymer and which is characterized by 1) being in the liquid state (or molten) at the extrusion temperature, 2) having a lower melt viscosity than the host polymer and fluoroelastomer, and 3) freely wets the surface of the fluoroelastomer particles in the extrudable composition. Examples of such interfacial agents include, but are not limited to, i) silicone-polyether copolymers; ii) aliphatic polyesters such as poly(butylene adipate), poly(lactic acid) and polycaprolactone polyesters-(preferably, the polyester is not a block copolymer of a dicarboxylic acid with a poly(oxyalkylene) polymer); iii) aromatic esters such as phthalic acid diisobutyl ester; iv) polyether polyols (preferably, not a polyalkylene oxide) such as poly(tetramethylene ether glycol); v) carboxylic acids such as hydroxy-butanedioic acid; vi) fatty acid esters, such as sorbitan monolaurate and triglycerides; and vii) poly(oxyalkylene) polymers. As used herein, the term “poly(oxyalkylene) polymers” refers to those polymers and their derivatives that are defined in U.S. Pat. No. 4,855,360. Such polymers include polyethylene glycols and their derivatives.

A preferred method for preparing copolymers of TFE and TFP is a semi-batch emulsion polymerization process as described in U.S. patent application Ser. No. 11/712,252. In the semi-batch process, a first gaseous monomer mixture is introduced into a reactor that contains an aqueous solution. The reactor is typically not completely filled with the aqueous solution, so that a vapor space remains. The aqueous solution may optionally comprise a fluorosurfactant dispersing agent, such as, for example, ammonium perfluorooctanoate, ammonium 3,3,4,4-tetrahydrotridecafluorooctanoate, Zonyl® FS-62 (available from DuPont) or Zonyl® 1033D (available from DuPont). Optionally, the aqueous solution may contain a pH buffer, such as a phosphate or acetate buffer, for controlling the pH of the polymerization reaction. Instead of a buffer, a base, such as NaOH, NH₄OH, or CsOH, may be used to control pH. Alternatively, or additionally, a pH buffer or base may be added to the reactor at various times throughout the polymerization reaction, either alone or in combination with other ingredients, such as polymerization initiator or chain transfer agent. Also optionally, the initial aqueous solution may contain a polymerization initiator, such as a water-soluble inorganic peroxide or an organic peroxide, for example hydrogen peroxide, ammonium persulfate (or other persulfate salt), di-tertiary butyl peroxide, disuccinic acid peroxide, and tertiary butyl peroxyisobutyrate. The initiator may be a combination of an inorganic peroxide and a reducing agent, such as the combination of ammonium persulfate and ammonium sulfite.

The amount of the first gaseous mixture charged to the reactor (sometimes referred to as “initial charge”) is set so as to result in a reactor pressure between about 0.3 MPa and 10 MPa. The composition of the first gaseous mixture consists of 95-100 mole percent TFE and 0-5 mol percent TFP. If the initial monomer charge contains greater than 5 mol percent TFP, the polymerization rate can be uneconomically slow or the reactor will have to be pressurized in excess of 10 MPa, which may lead to undesirable processing issues.

The first gaseous monomer mixture is dispersed in the aqueous solution while the reaction mixture is agitated, typically by mechanical stirring. The resulting mixture is termed a “reaction mixture”.

Optionally, a chain transfer agent, such as may also be introduced at this point in the process. The entire amount of chain transfer agent may be added at one time, or addition may be spread over time, up to the point when 100 percent of the second gaseous monomer mixture (as defined hereinafter) has been added to the reactor.

The temperature of the semi-batch reaction mixture is maintained throughout the polymerization process in the range of from about 25° C.-130° C., but 30° C.-90° C. is an optimal range. Polymerization begins when the initiator either thermally decomposes or reacts with reducing agent and the resulting radicals react with dispersed monomer to form a polymer dispersion.

Additional quantities of the monomers can be added at a controlled rate throughout the polymerization in order to maintain a desired reactor pressure at a controlled temperature. The relative ratio of the monomers in the second gaseous monomer mixture is set to be approximately the same as the desired ratio of copolymerized monomer units in the resulting fluoropolymer. Thus, the second gaseous monomer mixture consists of between 45 and 95 mole percent, based on the total moles of monomers in the monomer mixture, of TFE and between 5 and 55 mole percent of TFP. Additional chain transfer agent may, optionally, be added to the reactor at any point during this stage of the polymerization process. Additional fluorosurfactant and polymerization initiator may also be fed to the reactor during this stage.

The amount of copolymer formed is approximately equal to the cumulative amount of the second gaseous monomer mixture fed to the reactor. The molar ratio of monomers in the second gaseous monomer mixture is not necessarily exactly the same as that of the desired copolymerized monomer unit composition in the resulting dipolymer because the composition of the first gaseous monomer charge may not be exactly that required for the desired final dipolymer composition or because a portion of the monomers in the second gaseous monomer mixture may dissolve, without reacting, into the polymer particles already formed.

Total polymerization times in the semi-batch polymerization process are in the range of from 2 to 30 hours. The resulting dipolymer dispersion can be isolated, filtered, washed, and dried by conventional techniques.

It is known (U.S. Pat. No. 6,642,310) that fluoropolymer process aids function by depositing a fluoropolymer coating on internal die surfaces, and that large particles transfer fluoropolymer mass to the die surface more quickly than small particles. In practicing the present invention, therefore, it is desirable to control the weight average particle size of the TFE-TFP fluoropolymer process aid in the polymer composition which is to be extruded so that it is greater than 2 microns, but less than 10 microns, when the polymer reaches a point in the extrusion process immediately preceding the die (i.e., at the die entrance). For best results, the weight average particle size of the fluoropolymer should be greater than 4 microns, and even greater than 6 microns, as measured just prior to the die, provided that the weight average particle size of the fluoropolymer does not exceed about 40% of the narrowest cross section of the extrudate. If the fluoropolymer particles become larger than about 40% of the narrowest extrudate dimension, the fluoropolymer particles can form defects in the extrudate.

Three TFE-TFP fluoroplastics or fluoroelastomers produced for use according to the invention are shown below in Table 1.

TABLE 1
TFE-TFP Polymers

| | Wt % TFE | Wt % TFP |
|---|---|---|
| TFE-TFP 01 | 80 | 20 |
| TFE-TFP 02 | 70 | 30 |
| TFE-TFP 03 | 75 | 25 |

A specific copolymer preparation is shown below in Example 1.

### Example 1

A 33 L reactor was charged with 24 liters of water containing 0.50 wt. % perfluorohexylethylsulfonic acid surfactant and 14.4 grams isopropanol, and then with 548 g. of a 97 wt. % TFE/3 wt. % TFP monomer mixture to bring the pressure to 250 psig at 80° C. Reaction was initiated by adding 200 ml of 7% ammonium persulfate/5% diammonium phosphate solution. The reactor pressure was maintained at 250 psig by feeding a mixture of 75 wt % TFE and 25 wt % TFP to the reactor. A total of 17.5 g of ammonium persulfate was required to polymerize 8000 grams of monomer. The emulsion was freeze coagulated and extensively washed to form a white powder.

### Masterbatches for Extrusion Tests in LLDPE

The TFE-TFP polymers from Table 1 were compounded into linear low density polyethylene (LLDPE) (LL1001.59, Exxon-Mobil Corp.), as shown below in Table 2, to produce masterbatches suitable for use in extrusion tests. Viton® FreeFlow™ 40 fluoroelastomer process aid, a copolymer of 40 wt. % hexafluoropropylene (HFP) and 60 wt. % vinylidene fluoride (VF2) (available from DuPont Performance Elastomers LLC), was included as a comparative example.

The masterbatches in Table 2 were mixed using a Brabender® mixing bowl equipped with cam rotors. Each batch weighed 60 g, and was mixed at 50 rpm for 3 minutes at a temperature setpoint of 200° C.

TABLE 2
Masterbatches for extrusion tests

| | MB-1 | MB-2 | MB-3 | MB-4 |
|---|---|---|---|---|
| Polymer | wt % | wt % | wt % | wt % |
| LLDPE | 95 | 95 | 95 | 95 |
| Viton ® | 5 | | | |
| FreeFlow ™ 40 | | | | |
| TFE-TFP 01 | | 5 | | |
| TFE-TFP 02 | | | 5 | |
| TFE-TFP 03 | | | | 5 |

The masterbatches from Table 2 were cooled, granulated, and then blended with LLDPE at 2 wt % to yield an extrudable compositon that contained 1000 ppm (parts per million) fluoropolymer. Each extrudable composition was then passed through a 2 mm×40 mm capillary die fed by a 19.05 mm diameter single screw extruder operating at 35 rpm (revolutions per minute) with temperature set points of 200° C., 225° C., 250° C. (feed zone to exit zone), with a die temperature of 250° C. Before each extrusion test, the extruder and die were thoroughly purged to remove traces of fluoropolymer with a compound of diatomaceous earth in polyethylene, available from Ampacet Corp. as 807193. The Ampacet compound was then purged out with pure LLDPE. When baseline conditions of die pressure had been recovered during extrusion of pure LLDPE, the extrudable composition under test was introduced to the extruder.

Table 3 shows reduction in melt fracture as a function of extrusion time observed on the extrudates from the three inventive extrudable compositions and one comparative extrudable composition. All of the polymer processing aids produced and tested according to the invention were effective in eliminating initially present melt defects within the two-hour extrusion period, which is similar to performance observed with the conventional fluoroelastomer additive. Thus, all samples exhibited good adhesion to die surfaces.

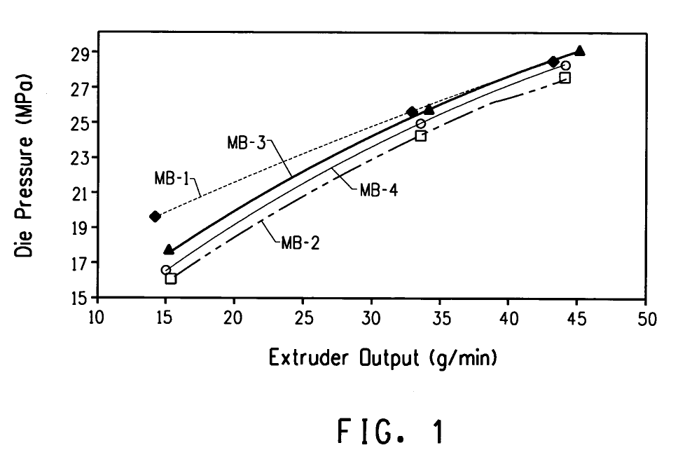

After two hours of extrusion at a screw speed of 35 rpm, the die pressure and extruder output were recorded. The extruder rpm was then increased to 50 rpm for 5 minutes, then 75 rpm for 5 minutes. After each 5-minute interval the extruder output and die pressure were recorded. Table 4, below, shows the recorded die pressure MPa (mega-Pascals) and the corresponding extruder output (g/min) for sample compositions produced and tested according to the invention as well as the comparative process aid. FIG. 1 graphically shows that the inventive compositions generally provide greater extruder output for a given die pressure than a conventional fluoroelastomer process aid.

TABLE 3
Percent melt fracture observed during extrusion

| Extrusion | MB-1 | | | |
|---|---|---|---|---|
| time (min) | comparative | MB-2 | MB-3 | MB-4 |
| 0 | 100 | 100 | 100 | 100 |
| 20 | 40 | 90 | 90 | 80 |
| 40 | 1 | 25 | 5 | 3 |
| 60 | 1 | 1 | 2 | 1 |
| 80 | 0 | 2 | 2 | 0 |
| 100 | 1 | 0 | 0 | 0 |
| 120 | 1 | 0 | 0 | 0 |

TABLE 4
Extruder output and die pressure at various screw speeds, after two hours
of extrusion at 35 rpm with 2 wt. % of the indicated
masterbatch in LLDPE

| | MB-1 | | MB-2 | | MB-3 | | MB-4 | |
|---|---|---|---|---|---|---|---|---|
| | Extruder | Die | Extruder | Die | Extruder | Die | Extruder | Die |
| Screw | output | pressure | output | pressure | output | pressure | output | pressure |
| speed | (g/min) | (MPa) | (g/min) | (MPa) | (g/min) | (MPa) | (g/min) | (MPa) |
| 35 rpm | 14.4 | 19.6 | 15. | 15.9 | 14.4 | 17.7 | 15 | 16.4 |
| 75 rpm | 32.4 | 25.6 | 33 | 24.1 | 32.4 | 25.8 | 32.9 | 29.4 |
| 100 rpm | 43.5 | 28.6 | 44.3 | 27.6 | 43.5 | 29.1 | 44.5 | 28.5 |

To demonstrate that the TFP moiety does not interfere with the slip of polar polymers, capillary rheometer experiments were conducted as follows. The fluoropolymer test samples produced as described herein were passed through an initially clean 0.762 mm×15.24 mm capillary die with a 30 degree entrance angle at a shear rate of 293 I/sec and a temperature as shown in Tables 5 and 6. The die was then removed from the rheometer, the barrel was cleaned, and the die re-installed without disturbing the fluoropolymer sample in the capillary portion of the die. Next, polar polymer (PET or nylon-6) was placed in the capillary barrel, and extruded under the same conditions. As the second polymer flowed through the die, it displaced most of the fluoropolymer, leaving only a thin layer on the die walls. The resulting measurement of apparent viscosity by the capillary rheometer provides a measure of the slip of the polar polymer on the remaining fluoropolymer coating.

TABLE 5
Polyethylene(terephthalate), 0.84 intrinsic viscosity, 270° C.

| Additive | Viscosity, Pa-s |
|---|---|
| None | 650.8 |
| TFE-TFP 01 | 449.9 |
| TFE-TFP 02 | 418.2 |
| TFE-TFP 03 | 387.1 |
| Viton ® FreeFlow ™ 40 | 642.4 |

TABLE 6
Extrusion grade nylon-6, unlubricated, 250° C.

| Additive | Viscosity, Pa-s |
|---|---|
| None | 408.0 |
| TFE-TFP 01 | 261.3 |
| TFE-TFP 02 | 307.9 |
| TFE-TFP 03 | 291.3 |
| Viton ® FreeFlow ™ 40 | 393.2 |

The test results indicate that fluoropolymers produced and used as a processing aid for melt-processable polymers according to the invention tend to provide excellent performance in extrusions of both polar and non-polar polymers.

What is claimed is:

1. An extrudable composition comprising a non-fluorinated, melt processable host polymer and from about 25 parts per million by weight to about 50% by weight, based on total weight of said extrudable composition, of a fluoropolymer consisting essentially of copolymerized units of the following monomers:
A) from 45 to 95 mole percent, based on total weight of said fluoropolymer, of tetrafluoroethylene (TFE); and
B) from 5 to 55 mole percent, based on total weight of said fluoropolymer, of 3,3,3-trifluoropropylene (TFP).

2. The composition of claim 1 wherein TFE is present in the fluoropolymer at a level of at least 70 mole percent, based on total weight of said fluoropolymer, and TFP is present in the fluoropolymer at a level of at least 15 mole percent, based on total weight of said fluoropolymer.

3. The composition of claim 1 wherein the weight average particle size of the fluoropolymer in the extrudable polymer composition is greater than 2 microns, but less than 10 microns.

4. The composition of claim 2 wherein the weight average particle size of the fluoropolymer in the extrudable polymer composition is greater than 2 microns, but less than 10 microns.

5. An extrudable composition comprising a non-fluorinated, melt processable host polymer, from about 25 parts per million by weight to about 50% by weight, based on total weight of said extrudable composition, of a fluoropolymer consisting essentially of copolymerized units of the following monomers:
A) from 45 to 95 mole percent, based on total weight of said fluoropolymer, of tetrafluoroethylene (TFE); and
B) from 5 and 55 mole percent, based on total weight of said fluoropolymer, of 3,3,3-trifluoropropylene (TFP), and
an interfacial agent where the weight ratio of interfacial agent to fluoropolymer ranges from 0.1 to 3.0.

6. The composition of claim 5 wherein TFE is present in the fluoropolymer at a level of at least 70 mole percent, based on total weight of said fluoropolymer, TFP is present in the fluoropolymer at a level of at least 15 mole percent, based on total weight of said fluoropolymer, and the weight ratio of interfacial agent to fluoropolymer is 0.2 to 2.0.

7. The composition of claim 5 wherein the weight average particle size of the fluoropolymer in the extrudable polymer composition is greater than 2 microns, but less than 10 microns.

8. The composition of claim 6 wherein the weight average particle size of the fluoropolymer in the extrudable polymer composition is greater than 2 microns, but less than 10 microns.

9. A method for improving extrusion characteristics of a non-fluorinated melt-processable polymer comprising incorporating into said
polymer from about 25 parts per million by weight to about 50% by weight, based on total weight of said polymer, of a fluoropolymer consisting essentially of copolymerized units of the following monomers:
A) from 45 to 95 mole percent, based on total weight of said fluoropolymer, of tetrafluoroethylene (TFE); and
B) from 5 to 55 mole percent, based on total weight of said fluoropolymer, of 3,3,3-trifluoropropylene (TFP).

10. The method of claim 9 wherein TFE is present in the fluoropolymer at a level of at least 70 mole percent, based on total weight of said fluoropolymer, and TFP is present in the fluoropolymer at a level of at least 15 mole percent, based on total weight of said fluoropolymer.

11. The method of claim 9 wherein the weight average particle size of the fluoropolymer in the melt-processable polymer is greater than 2 microns, but less than 10 microns.

12. The method of claim 10 wherein the weight average particle size of the fluoropolymer in the melt-processable polymer is greater than 2 microns, but less than 10 microns.

13. The method of claim 9 further comprising incorporating an interfacial agent into said polymer where the weight ratio of interfacial agent to fluoropolymer ranges from 0.1 to 3.0.
